(19) United States
(12) Patent Application Publication
(10) Pub. No.: US 2026/0134080 A1
(43) Pub. Date: May 14, 2026

(54) CROSS-INSTITUTION CLINICAL AI CREDENTIALING, TRUST SCORING, AND AUTHORIZATION SYSTEM

(71) Applicant: George William Bickerstaff, III, Greenwich, CT (US)

(72) Inventor: George William Bickerstaff, III, Greenwich, CT (US)

(21) Appl. No.: 19/445,481

(22) Filed: Jan. 10, 2026

(51) Int. Cl. G06F 21/44; G06F 21/45; G06F 21/55

(52) U.S. Cl. CPC G06F 21/44; G06F 21/45; G06F 21/552; G06F 2221/033

(57) ABSTRACT

A cross-institution clinical artificial intelligence credentialing, trust scoring, and authorization system evaluates model provenance and institutional context, computes trust scores, issues version-specific authorization decisions, and records immutable audit artifacts to control deployment of clinical AI models across multiple institutions.

### TECHNICAL FIELD

The present invention relates to clinical artificial intelligence governance systems and, more particularly, to systems and methods for credentialing, trust scoring, and authorization of clinical artificial intelligence models across multiple independent institutions.

### BACKGROUND

Clinical artificial intelligence systems are increasingly deployed within healthcare institutions to support data analysis, workflow prioritization, diagnostic assistance, and clinical decision support.

Existing credentialing approaches for such systems are typically institution-specific, static, and manually administered, relying on documentation review and policy approval rather than continuous technical validation.

These approaches fail to account for model versioning, provenance changes, deployment context, and evolving performance characteristics that materially affect clinical risk.

As clinical artificial intelligence models are shared, updated, and deployed across multiple institutions, the absence of cross-institution credentialing and trust evaluation creates governance, safety, and accountability challenges.

Accordingly, there exists a need for a technical system that enables version-specific credentialing, trust scoring, and authorization of clinical artificial intelligence models across multiple institutions in a controlled, auditable, and repeatable manner.

### SUMMARY OF THE INVENTION

The invention provides a cross-institution clinical artificial intelligence credentialing system configured to evaluate model provenance, institutional deployment context, and operational constraints prior to deployment.

The system computes trust scores for clinical artificial intelligence models using structured model metadata, institution profiles, and historical performance indicators.

Authorization decisions are issued on an institution-specific and version-specific basis, thereby preventing unauthorized or unverified deployment of clinical artificial intelligence models.

All credentialing, trust scoring, authorization, and reauthorization actions are recorded in immutable audit artifacts to enable traceability, oversight, and post-deployment review.

### Definitions (Alphabetical Order)

Audit Artifact refers to an immutable, time-stamped record capturing credentialing, trust scoring, authorization, and reauthorization actions associated with a clinical artificial intelligence model.

Authorization Decision refers to a system-generated determination permitting, restricting, or denying deployment of a clinical artificial intelligence model within a specific institutional environment.

Clinical AI Model refers to a software-based artificial intelligence system configured to perform computational analysis on clinical data within a defined and approved use scope.

Credentialing Request refers to a machine-generated request to evaluate whether a clinical artificial intelligence model may be deployed at a specific institution.

Cross-Institution Deployment refers to deployment of the same clinical artificial intelligence model across multiple independent institutions under institution-specific authorization decisions.

Deployment Token refers to a machine-readable authorization artifact encoding approved deployment scope, constraints, and version-specific permissions.

Institution Profile refers to a structured data record describing an institution's technical infrastructure, governance controls, operational policies, and deployment constraints.

Reauthorization Trigger refers to a detected event requiring reevaluation of an authorized clinical artificial intelligence model, including model updates, performance changes, or context modifications.

Trust Score refers to a quantitative or categorical value representing deployment suitability of a clinical artificial intelligence model within a specific institutional context.

Version-Specific Authorization refers to an authorization constraint that binds deployment approval to a particular version of a clinical artificial intelligence model.

### BRIEF DESCRIPTION OF THE DRAWINGS

FIG. 1 illustrates cross-institution AI credentialing.

FIG. 2 illustrates a model credentialing workflow.

FIG. 3 illustrates trust and authorization flow.

FIG. 4 illustrates cross-institution deployment control.

FIG. 5 illustrates audit and oversight.

### DETAILED DESCRIPTION

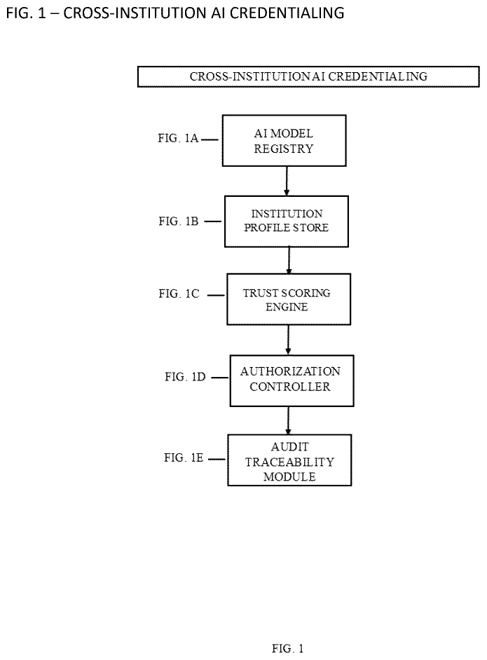

### FIG. 1—Cross-Institution AI Credentialing

FIG. 1 illustrates a system architecture for credentialing artificial intelligence models across multiple independent institutions. The architecture integrates model registration, institutional profiling, trust scoring, authorization, and audit traceability. Credentialing decisions are institution-specific and version-specific.

FIG. 1A—AI MODEL REGISTRY. FIG. 1a depicts a registry storing identifiers, version information, provenance metadata, and approved use scopes for clinical artificial intelligence models. The registry serves as an authoritative source for credentialing evaluation. Registry entries are referenced throughout trust scoring and authorization workflows.

FIG. 1B—INSTITUTION PROFILE STORE. FIG. 1b illustrates a data store containing institution-specific deployment attributes. Stored attributes include infrastructure capabilities, governance controls, and operational constraints. The institution profile store contextualizes trust scoring decisions.

FIG. 1C—TRUST SCORING ENGINE. FIG. 1C depicts an engine configured to compute trust scores for clinical artificial intelligence models. Trust scores are calculated using model attributes and institution profiles. Computed scores represent deployment suitability.

FIG. 1D—AUTHORIZATION CONTROLLER. FIG. 1D illustrates a controller that issues deployment authorization decisions. Authorization decisions are based on trust scores and predefined thresholds. Decisions may permit, restrict, or deny deployment.

FIG. 1E—AUDIT TRACEABILITY MODULE. FIG. 1E depicts a module that records credentialing, trust scoring, and authorization events. Records are immutable and time-stamped. Stored audit artifacts support traceability and review.

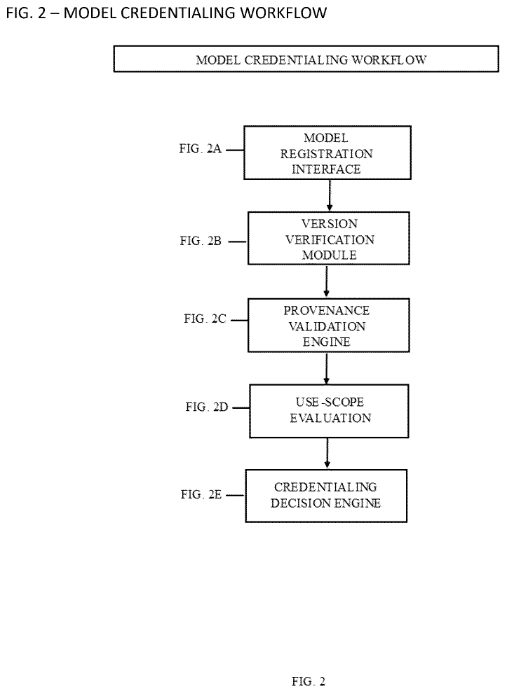

### FIG. 2—Model Credentialing Workflow

FIG. 2 illustrates a workflow for credentialing a clinical artificial intelligence model prior to deployment. The workflow progresses through registration, validation, evaluation, and decision stages. Each stage produces auditable outputs.

FIG. 2A—MODEL REGISTRATION INTERFACE. FIG. 2A depicts an interface through which clinical artificial intelligence models are registered. Registration includes submission of identifiers and metadata. Submitted information initiates the credentialing workflow.

FIG. 2B—VERSION VERIFICATION MODULE. FIG. 2B illustrates verification of model version information. Version identifiers are validated against registry records. Verification enforces version-specific credentialing.

FIG. 2C—PROVENANCE VALIDATION ENGINE. FIG. 2C depicts validation of model provenance data. Provenance includes training sources and validation artifacts. Validated provenance contributes to trust scoring.

FIG. 2D—USE-SCOPE EVALUATION. FIG. 2D illustrates evaluation of the requested deployment use scope. Requested scope is compared against approved use definitions. Mismatches generate restriction signals.

FIG. 2E—CREDENTIALING DECISION ENGINE. FIG. 2E depicts generation of a credentialing decision. The decision determines whether the model may proceed to trust scoring. Outcomes are recorded as audit artifacts.

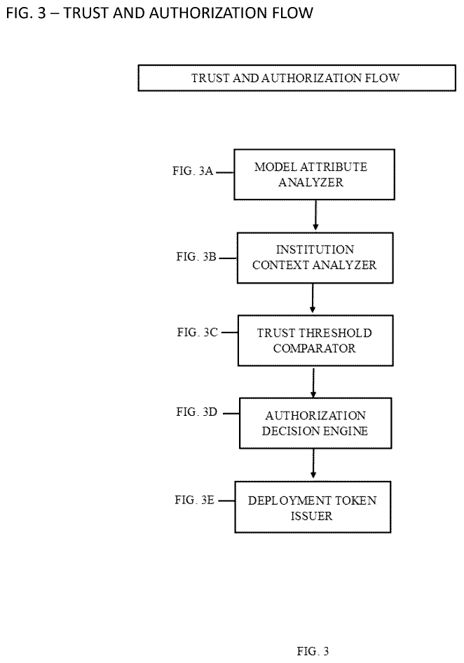

### FIG. 3—Trust and Authorization Flow

FIG. 3 illustrates the flow of trust scoring and authorization decisions. Model attributes and institutional context are evaluated. Authorization enforces deployment constraints.

FIG. 3A—MODEL ATTRIBUTE ANALYZER. FIG. 3A depicts analysis of clinical artificial intelligence model attributes. Attributes include performance metrics and validation status. Analyzed attributes feed trust scoring.

FIG. 3B—INSTITUTION CONTEXT ANALYZER. FIG. 3B illustrates evaluation of institutional deployment context. Context includes infrastructure readiness and governance controls. Contextual analysis tailors trust scoring.

FIG. 3C—TRUST THRESHOLD COMPARATOR. FIG. 3C depicts comparison of trust scores against predefined thresholds. Thresholds define acceptable deployment risk. Comparison results determine authorization outcomes.

FIG. 3D—AUTHORIZATION DECISION ENGINE. FIG. 3D illustrates issuance of authorization decisions. Decisions may include conditional or limited permissions. All decisions are logged.

FIG. 3E—DEPLOYMENT TOKEN ISSUER. FIG. 3E depicts issuance of a deployment authorization token. Tokens encode approved scope and constraints. Tokens are required for operational use.

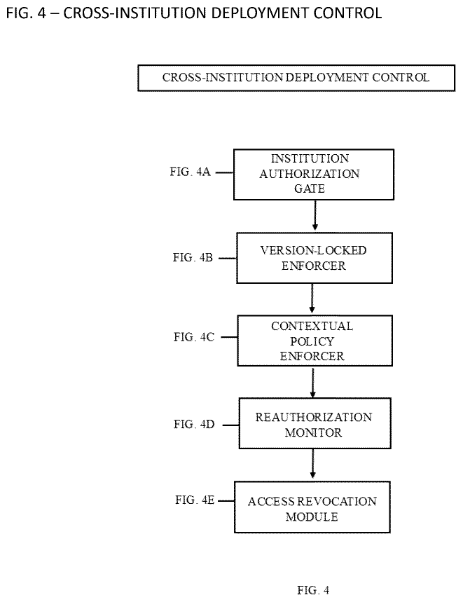

### FIG. 4—Cross-Institution Deployment Control

FIG. 4 illustrates enforcement of deployment authorization across institutions. Each institution is evaluated independently. Authorization does not transfer automatically.

FIG. 4A—INSTITUTION AUTHORIZATION GATE. FIG. 4A depicts a gate enforcing institution-specific authorization. Only authorized models may pass the gate. Unauthorized access is blocked.

FIG. 4B—VERSION-LOCKED ENFORCER. FIG. 4B illustrates enforcement of version-specific authorization. Deployment is restricted to approved versions. Unauthorized version changes are rejected.

FIG. 4C—CONTEXTUAL POLICY ENFORCER. FIG. 4C depicts enforcement of contextual deployment policies. Policies constrain operational parameters. Enforcement occurs in real time.

FIG. 4D—REAUTHORIZATION MONITOR. FIG. 4D illustrates monitoring for reauthorization triggers. Triggers include model updates or performance changes. Detected triggers initiate reassessment.

FIG. 4E—ACCESS REVOCATION MODULE. FIG. 4E depicts revocation of deployment authorization. Revocation occurs when trust conditions are no longer satisfied. Revoked access is recorded.

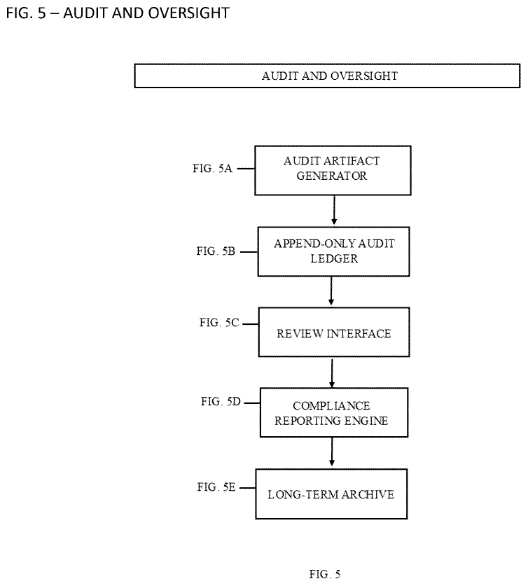

### FIG. 5—Audit and Oversight

FIG. 5 illustrates audit and oversight of credentialing and authorization activity. All actions are recorded deterministically. Records support compliance and governance.

FIG. 5A—AUDIT ARTIFACT GENERATOR. FIG. 5A depicts generation of audit artifacts capturing credentialing and authorization events. Artifacts are immutable and time-stamped.

FIG. 5B—APPEND-ONLY AUDIT LEDGER. FIG. 5B illustrates storage of artifacts in an append-only ledger. Ledger entries cannot be modified.

FIG. 5C—REVIEW INTERFACE. FIG. 5C depicts an interface for authorized review of audit records. Access is controlled.

FIG. 5D—COMPLIANCE REPORTING ENGINE. FIG. 5D illustrates generation of compliance reports summarizing credentialing and authorization activity.

FIG. 5E—LONG-TERM ARCHIVE. FIG. 5E depicts archival storage of audit records supporting retention requirements.

### Illustrative Operational Example

In one example, a first healthcare institution requests deployment of a clinical artificial intelligence model configured for radiological image prioritization.

The trust scoring engine evaluates model attributes, institutional context, and historical performance to generate a trust score.

Based on the trust score, the system issues a conditional authorization decision and records an audit artifact.

A second healthcare institution independently requests access to the same model, triggering a separate credentialing and trust evaluation.

Authorization decisions are institution-specific, version-specific, and independently auditable.

1. A cross-institution clinical artificial intelligence credentialing system comprising:
a clinical artificial intelligence model registry configured to store identifiers, version information, provenance metadata, and approved use scopes;
an institution profile store configured to store deployment attributes associated with multiple independent institutions;
a trust scoring engine configured to compute a trust score for a clinical artificial intelligence model based on at least the model registry and an institution profile;
an authorization controller configured to issue an authorization decision permitting, restricting, or denying deployment of the clinical artificial intelligence model at a specific institution based on the trust score; and
an audit traceability module configured to generate immutable audit artifacts recording credentialing, trust scoring, and authorization actions.

2. A method for cross-institution credentialing of clinical artificial intelligence models, comprising:
registering a clinical artificial intelligence model with version and provenance information;
evaluating an institution profile corresponding to a requesting institution;
computing a trust score;
issuing an authorization decision; and
recording the authorization decision in an immutable audit artifact.

3. A non-transitory computer-readable medium storing instructions that, when executed by one or more processors, cause the processors to perform the method of claim 2.

4. The system of claim 1, wherein the authorization decision is bound to a specific model version.

5. The system of claim 1, wherein the trust scoring engine computes the trust score using historical performance metrics.

6. The method of claim 2, wherein the authorization decision includes issuance of a deployment token encoding approved deployment scope and constraints.

7. The method of claim 2, further comprising detecting a reauthorization trigger and recomputing the trust score in response to the reauthorization trigger.

8. The system of claim 1, wherein deployment is restricted by institution-specific constraints.

9. The non-transitory computer-readable medium of claim 3, wherein audit artifacts are stored in an append-only audit ledger.

10. The system of claim 1, wherein authorization for deployment at a first institution does not authorize deployment at a second institution.
